(19) United States
(12) Patent Application Publication
(10) Pub. No.: US 2026/0296391 A1
(43) Pub. Date: Oct. 1, 2026

(54) CONTROL DEVICE AND METHOD FOR OPERATING AN EXTERNAL POWER BRAKE SYSTEM OF A VEHICLE

(71) Applicant: Robert Bosch GmbH, Stuttgart (DE)

(72) Inventors: Michael Kunz, Steinheim (DE); Thorsten Maucher, Heidelberg (DE)

(21) Appl. No.: 19/573,620

(22) Filed: Mar. 20, 2026

(30) Foreign Application Priority Data
Mar. 28, 2025 (DE) 10 2025 112 063.3

(51) Int. Cl. B60T 13/74

(52) U.S. Cl. CPC B60T 13/745; B60T 2270/413

(57) ABSTRACT

A control device for an external power brake system of a vehicle. An external power brake system, in particular an axle brake module, for a vehicle is also described. A method for operating an external power brake system of a vehicle is also described.

### CROSS REFERENCE

The present application claims the benefit under 35 U.S.C. § 119 of Germany Patent Application No. DE 10 2025 112 063.3 filed on Mar. 28, 2025, which is expressly incorporated herein by reference in its entirety.

### FIELD

The present disclosure relates to a control device for an external power brake system of a vehicle. The present disclosure also relates to an external power brake system, in particular an axle brake module, for a vehicle. The present disclosure further relates to a method for operating an external power brake system of a vehicle.

### BACKGROUND INFORMATION

Today's vehicles are equipped with centralized brake system architectures. It is typically divided into actuation (brake force amplification), modulation (ESP) and foundation (wheel braking). In the actuation stage, the driver's pedal force is increased, for example, by electromechanical brake force amplification, while the wheel-individual brake pressure control is typically implemented in a second brake module (ESP). Newer systems additionally allow the driver to be decoupled when the system is functioning correctly, which can improve recuperation capability (brake blending) and pedal feel. However, such systems still provide a mechanical fallback option in case of failure, whereby the driver is mechanically or hydraulically coupled to the wheel brake. Such systems are implemented in the form of an integrated brake regulating unit or in the form of two separate boxes.

In the future, so-called true-by-wire systems will become relevant, in which the driver's request is detected by an electrically connected brake pedal. Such systems have no mechanical fallback option. Currently, centralized brake system architectures are used. The required redundancy is achieved by the use of a box featuring integrated redundancy or with two boxes, each with its own brake actuator. However, all four wheels of the vehicle are always centrally supplied with brake pressure. Instead of centralized architectures, in which all four wheels are connected to one or two central boxes, so-called by-wire axle modules can also be used. These generate the brake pressure for two wheels of an axle in each case. This eliminates the need for long brake lines running from the engine compartment to the rear axle. This offers flexibility in terms of wheelbase and production.

Even electromechanical brake systems (EMB) may also go into series production in the future. They belong to the so-called decentralized brake systems group, in which a brake actuator (motor-gearbox unit) is responsible for generating the braking torque at that specific wheel. For some vehicles, the braking force provided by an electromechanical brake system may not be sufficient, so that hydraulic wheel actuators (motor-pump or motor-plunger unit (possibly with valves)) are also possible. The actuators of a decentralized brake system are typically installed directly on the wheel or at least close to the wheel. Decentralized systems offer advantages in terms of controllability due to the complete independence of the two wheel modules of an axle, as well as packaging advantages due to the freed-up space in the engine compartment and the elimination of the brake lines that in conventional brake systems have to be routed through the vehicle. In addition, with EMB the brake fluid and its replacement can be omitted.

Various layouts and redundancy concepts are available. For example, Germany Patent Application No. DE 10 2004 052 783 A1 describes a method and a device for stabilizing the driving state of a vehicle with an all-wheel drive. To further improve vehicle stabilization compared to conventional traction control or ESP systems, the following steps are proposed therein: determining a deviation between an actual torque currently applied to a wheel or axle and a target torque specified for the wheel or axle of the vehicle, ascertaining a maximum possible frictional contact, during such deviation, between a tire assigned to the wheel or axle and a road surface on which the tire is currently rolling, changing the originally specified target torque for the wheel or axle to a modified value represented by the ascertained maximum frictional contact, and controlling the actual torque to the modified target torque.

Furthermore, Germany Patent Application No. DE 10 2020 216 322 A1 describes a brake system for a vehicle with at least two axles, comprising a first axle unit with a first motorized brake pressure building device, a first wheel brake cylinder hydraulically connected to the first motorized brake pressure building device and mountable on a first wheel of a first axle of the vehicle, and a second wheel brake cylinder hydraulically connected to the first motorized brake pressure building device and mountable on a second wheel of the first axle, and a second axle unit hydraulically separated from the first axle unit, wherein the first axle unit has, in addition to the first motorized brake pressure building device, a second motorized brake pressure building device to which the first wheel brake cylinder and the second wheel brake cylinder are hydraulically connected. The present disclosure also relates to a method for operating a brake system of a vehicle having at least two axles.

Conventional 2-box axle modules have the disadvantage that, depending on the desired wheel torque, different actuators with different strategies must be controlled. The advantage of the EMB being able to independently adjust wheel torques is therefore not possible at the wheels of the front axle. This leads to a disadvantage in centralized architectures, since they are based on individual wheel control.

### SUMMARY

The present disclosure includes a control device for an external power brake system of a vehicle, an external power brake system for a vehicle, and a method for operating an external power brake system of a vehicle.

According to a first aspect of the present disclosure, a control device for an external power brake system of a vehicle is provided. According to an example embodiment of the present disclosure, the control device comprises a primary electronic device which is designed and/or programmed in such a way that a motor of a motorized piston cylinder device of the external power brake system can be controlled by means of the primary electronic device such that at least one fluid intake volume of the motorized piston cylinder device can be varied by means of the controlled motor. In addition, at least one first valve and at least one second valve of the external power brake system can be switched by means of the primary electronic device, wherein a first wheel brake cylinder of the external power brake system is hydraulically connected to the at least one fluid intake volume at least via the at least one first valve and a second wheel brake cylinder of the external power brake system at least via the at least one second valve. The primary electronic device is additionally designed and/or programmed in such a way that a brake pressure maintenance or brake pressure increase function for the first wheel brake cylinder and a brake pressure reduction function for the second wheel brake cylinder can be performed simultaneously by means of the primary electronic device in that at least, while a brake fluid transfer from the first wheel brake cylinder into the at least one fluid intake volume increased by means of the controlled motor is prevented by means of the at least one first valve that is switched to be closed, brake fluid from the second wheel brake cylinder can be drawn into the at least one increased fluid intake volume via the at least one second valve that is switched to be at least partially open. The control device further comprises a secondary electronic device which is designed and/or programmed in such a way that, in an electrical fault condition of the external power brake system, the secondary electronic device can either control the motor such that at least one fluid intake volume of the motorized piston cylinder device can be varied by means of the controlled motor such that a brake pressure maintenance or brake pressure increase function can be performed for the first wheel brake cylinder and for the second wheel brake cylinder; or that the at least one first valve and the at least one second valve can be switched such that a brake pressure maintenance or brake pressure increase function can be performed for the first wheel brake cylinder and for the second wheel brake cylinder.

According to a second aspect of the present disclosure, an external power brake system, in particular axle brake module, is provided for a vehicle. According to an example embodiment, the external power brake system comprises a control device according to the first aspect of the present disclosure. The external power brake system further comprises the motorized piston cylinder device, the motor of which can be controlled by means of the primary and the secondary electronic device of the control device such that the at least one fluid intake volume of the motorized piston cylinder device can be varied by means of the controlled motor. The external power brake system further comprises the first wheel brake cylinder, which can be, or is, arranged on an axle of the vehicle, and the second wheel brake cylinder, which can be, or is, arranged on the axle of the vehicle. In addition, the external power brake system comprises the first and second valves which can be switched by means of the primary and the secondary electronic device, wherein the first wheel brake cylinder is hydraulically connected to the at least one fluid intake volume at least via the at least one first valve and the second wheel brake cylinder at least via the at least one second valve.

According to a third aspect of the present disclosure, a method for operating an external power brake system of a vehicle is provided. According to an example embodiment, the method simultaneously performs a brake pressure maintenance or brake pressure increase function for a first wheel brake cylinder of the external power brake system arranged on an axle of the vehicle and a brake pressure reduction function for a second wheel brake cylinder of the external power brake system arranged on the axle of the vehicle. The method further comprises the following steps.

Controlling a motor of a motorized piston cylinder device of the external power brake system such that at least one fluid intake volume of the motorized piston cylinder device is increased by means of the controlled motor.

Switching at least one first valve of the external power brake system in such a way that, while the first wheel brake cylinder is hydraulically connected to the at least one fluid intake volume at least via the at least one first valve, a brake fluid transfer from the first wheel brake cylinder into the at least one fluid intake volume increased by means of the controlled motor is prevented by means of the at least one first valve that is switched to be closed.

Switching at least one second valve of the external power brake system in such a way that, while the second wheel brake cylinder is hydraulically connected to the at least one fluid intake volume via the at least one second valve, brake fluid is drawn from the second wheel brake cylinder into the at least one increased fluid intake volume via the at least one second valve that is switched to be at least partially open.

In the event of an electrical fault condition of the external power brake system, a secondary electronic device is used to either

control the motor such that at least one fluid intake volume of the motorized piston cylinder device is varied by means of the controlled motor such that a brake pressure maintenance or brake pressure increase function is performed for the first wheel brake cylinder and for the second wheel brake cylinder; or

switch the at least one first valve and the at least one second valve such that a brake pressure maintenance or brake pressure increase function is performed for the first wheel brake cylinder and for the second wheel brake cylinder.

One of the underlying features of the present disclosure is to provide a control device or regulating device and an axle brake module with such a control device that controls two electrically and spatially separated actuators or actuator modules such that two wheel braking torques can be controlled independently and in an NVH-optimized manner.

The electrical fault condition can, for example, affect the motorized piston cylinder device or one of the first or second valves. An advantage of the present disclosure is that a brake pressure of the first and second wheel brake cylinders can be regulated individually for each wheel and also optimized for noise reduction, in particular making it quieter. For example, the control device according to the present disclosure can reduce a braking torque at a wheel or wheel brake cylinder by locking in the brake pressure at the wheel with higher brake pressure by activating the associated first valve and then reducing the brake pressure at the wheel where the hydraulic braking torque is to be reduced via the motorized piston cylinder device.

Advantageously, the present disclosure uses a motorized piston cylinder device, which is often already used in an external power brake system, to control the wheel-individual braking torques, so that a realization of the present disclosure does not require any hardware expansion of the respective external power brake system. Instead, to implement the present disclosure, it is generally sufficient to simply reprogram a control device of the respective external power brake system. This facilitates the use of the present disclosure in a wide variety of different vehicle types.

A further advantage of the present disclosure is that, in an external power brake system equipped with the motorized piston cylinder device, a driver of the vehicle equipped with the external power brake system (usually) does not brake into the external power brake system. The driver, who instead brakes into a simulator by operating a brake actuation element/brake pedal, is therefore not bothered by the simultaneous use of the motorized piston cylinder device of the external power brake system to effect the brake pressure reduction function. The present disclosure thus continues to offer the driver a standard brake actuation feel/pedal feel.

Advantageous embodiments and developments can be found in the disclosure herein.

According to a development of the present disclosure, the primary electronic device is additionally designed and/or programmed in such a way that a brake pressure increase function for the first wheel brake cylinder and a brake pressure reduction function for the second wheel brake cylinder can be performed simultaneously by means of the primary electronic device in that simultaneously, while a brake fluid transfer from the first wheel brake cylinder into the at least one fluid intake volume increased by means of the controlled motor is prevented by means of the at least one first valve that is switched to be closed, and brake fluid from the second wheel brake cylinder can be drawn into the at least one increased fluid intake volume via the at least one second valve that is switched to be at least partially open, a pump motor of at least one pump of the external power brake system can additionally be activated by means of the primary electronic device such that brake fluid can be pumped into the first wheel brake cylinder by means of the at least one activated pump. In this way, the control device takes advantage of the fact that when the external power brake system is equipped with the motorized piston cylinder device and the at least one pump as its two actuators, operation of the at least one pump is not/hardly affected by closing the at least one first valve. For this reason, the motorized piston cylinder device for brake pressure reduction can be used in the second wheel brake cylinder and at the same time the at least one pump for brake pressure increase can be used in the first wheel brake cylinder. In this way, a reduction in braking torque can be achieved at one wheel or wheel brake cylinder and a build-up of braking torque at the other wheel or wheel brake cylinder of a common axle.

According to a further development of the present disclosure, the primary electronic device is additionally designed and/or programmed in such a way that a first brake pressure reduction function with a first target gradient for the first wheel brake cylinder and a second brake pressure reduction function with a second target gradient above the first target gradient for the second wheel brake cylinder can be performed simultaneously by means of the primary electronic device in that, during a brake fluid transfer from the second wheel brake cylinder via the at least one second valve, that is switched to be at least partially open, into the at least one fluid intake volume increased by means of the controlled motor, a brake fluid transfer from the first wheel brake cylinder into the at least one increased fluid intake volume is interrupted several times by means of the at least one first valve that is switched to be briefly closed. In this way a simultaneous reduction of braking torque can be effected at both wheel brake cylinders with different target gradients. For the wheel or wheel brake cylinder with higher brake pressure, a target brake pressure can be set by changing the flow of the first valve, and for the wheel or wheel brake cylinder with lower target brake pressure, it can be regulated via the motorized piston cylinder device or plunger.

According to a further development of the present disclosure, the primary electronic device is additionally designed and/or programmed in such a way that a first brake pressure increase function with a first target gradient for the first wheel brake cylinder and a second brake pressure increase function with a second target gradient above the first target gradient for the second wheel brake cylinder can be performed simultaneously by means of the primary electronic device in that the motor can be activated such that a brake fluid transfer from the fluid intake volume reduced by means of the controlled motor into the first wheel brake cylinder and into the second wheel brake cylinder is effected, wherein the first valve is controlled depending on the first target gradient. In this way, a braking torque build-up can be achieved on both wheel brakes of a common axle with different target gradients. Here the brake pressure in the lower wheel can be reduced proportionally more slowly while the other wheel is held steady.

According to a further development of the present disclosure, the control device is designed as the central control unit of the vehicle. In addition, a third wheel brake cylinder of another axle of the vehicle can be coupled to the control device, in particular to the central control unit. In this way, the central control unit can control the wheel brake cylinders connected to it as if the vehicle were equipped with four decentralized brake actuators.

According to a further development of the present disclosure, the axle is designed as the rear axle of the vehicle, wherein the motorized piston cylinder device, the at least one first valve and the at least one second valve are arranged on the rear axle.

According to a further development of the present disclosure, a brake pressure increase function for the first wheel brake cylinder and a brake pressure reduction function for the second wheel brake cylinder are performed simultaneously in that simultaneously, while a brake fluid transfer from the first wheel brake cylinder into the at least one fluid intake volume increased by means of the controlled motor is prevented by means of the at least one first valve that is switched to be closed, and brake fluid from the second wheel brake cylinder is drawn into the at least one increased fluid intake volume via the at least one second valve that is switched to be at least partially open, a pump motor of at least one pump of the external power brake system is additionally activated such that brake fluid is pumped into the first wheel brake cylinder by means of the at least one activated pump.

According to a further development of the present disclosure, a first brake pressure reduction function with a first target gradient for the first wheel brake cylinder and a second brake pressure reduction function with a second target gradient above the first target gradient for the second wheel brake cylinder are simultaneously performed in that, during a brake fluid transfer from the at least one fluid intake volume reduced by means of the controlled motor via the at least one second valve, that is switched to be at least partially open, into the second wheel brake cylinder, a brake fluid transfer from the at least one reduced fluid intake volume is interrupted several times by means of the at least one first valve that is switched to be briefly closed.

According to a further development of the present disclosure, a first brake pressure increase function with a first target gradient for the first wheel brake cylinder and a second brake pressure increase function with a second target gradient above the first target gradient for the second wheel brake cylinder are performed simultaneously in that the motor is activated such that a brake fluid transfer from the fluid intake volume reduced by means of the controlled motor into the first wheel brake cylinder and into the second wheel brake cylinder is effected, wherein the first valve is controlled depending on the first target gradient.

The subject matter of the present disclosure presented above will be explained again and in more detail below in different words: This idea – in simplified terms – concerns an axle brake module with a regulating device or control device that controls two electrically and spatially separated actuator modules or actuators such that two wheel torques can be controlled independently and in an NVH-optimized manner. The regulating device has a primary and a secondary regulator or electronic device, wherein the primary regulator in a fault-free state takes over the coordination of the two actuators. Furthermore, the wheel-individual brake pressure is controlled in an NVH-optimized manner, wherein regulation is based on a gradient. In the event of an electrical fault or fault condition of one of the two control modules or actuator modules, both wheels of an axle can be braked using the remaining intact actuator.

### BRIEF DESCRIPTION OF THE DRAWINGS

The present disclosure is explained below with reference to the figures.

FIG. 1 shows a schematic representation of an example embodiment of the external power brake system or of the control device interacting therewith.

FIG. 2 shows a flowchart explaining an example embodiment of the method for operating an external power brake system of a vehicle.

In the figures, identical reference signs denote identical or functionally identical components, unless stated otherwise. The numbering of method steps serves the purpose of clarity and is generally not intended to imply a specific chronological order. In particular, a plurality of method steps may also be carried out simultaneously.

### DETAILED DESCRIPTION OF EXAMPLE EMBODIMENTS

Further advantages, features and details of the present disclosure will become apparent from the following description, in which various exemplary embodiments are described in detail with reference to the figures.

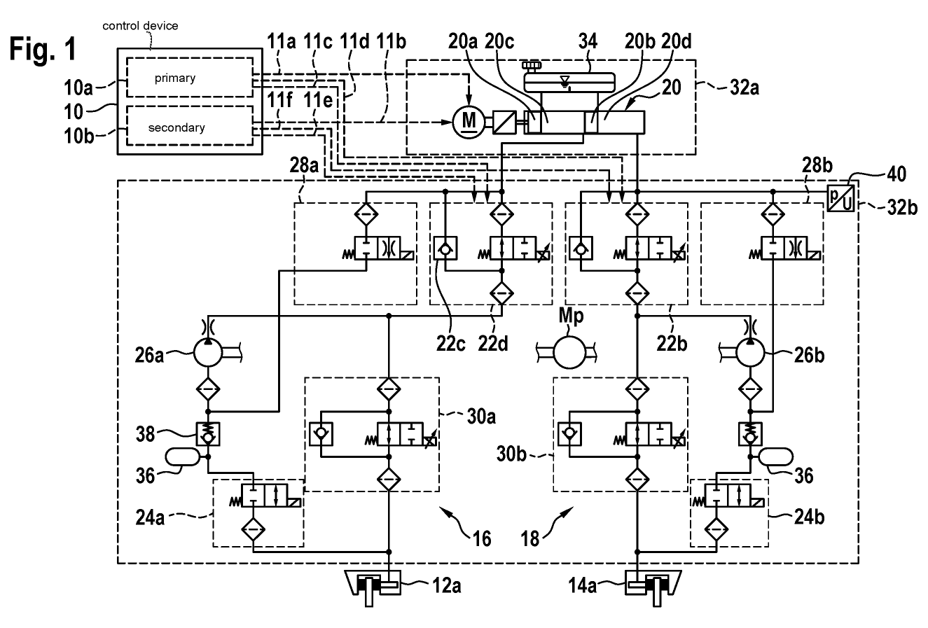

FIG. 1 shows a schematic representation of an embodiment of the external power brake system or of the control device 10 interacting therewith.

It should be noted that the applicability of the control device 10 and the external power brake system of FIG. 1 interacting therewith is not limited to any specific vehicle type/motor vehicle type. Instead, the control device 10 and the external power brake system can be mounted on (almost) any vehicle/motor vehicle which has two wheels mounted on a common axle of the vehicle/motor vehicle. The vehicle equipped with the external power brake system can be, for example, a passenger car, a truck, or an off-highway vehicle.

The external power brake system in FIG. 1 has a first wheel brake cylinder 12a and a second wheel brake cylinder 14a, wherein the first wheel of the vehicle can be/is braked by means of the first wheel brake cylinder 12a and the second wheel of the vehicle can be/is braked by means of the second wheel brake cylinder 14a. For the brake pressure present in the first wheel brake cylinder 12a, a maximum can be defined as the first maximum brake pressure and a minimum as the first minimum brake pressure. Accordingly, the maximum brake pressure present in the second wheel brake cylinder 14a will henceforth be referred to as the second maximum brake pressure and its minimum as the second minimum brake pressure.

The control device 10 interacting with the external power brake system can be at least a part of the external power brake system or at least a unit that can be mounted/is mounted separately from the external power brake system. Although the control device 10 is depicted as a one-piece controller in FIG. 1, the design possibilities of the control device 10 are not limited to this. For this reason, the functions performed by the control device 10 or its primary and secondary electronic devices 10a, 10b can also be performed by several separate units.

The primary electronic device 10a of the control device 10 is designed and/or programmed in such a way that a motor M of a motorized piston cylinder device 20 of the external power brake system and at least one first valve 22a and at least one second valve 22b can be controlled/are controlled by means of the primary electronic device 10a. The motor M of the motorized piston cylinder device 20 is controllable/controlled by means of at least one motor control signal 11a output by the primary electronic device 10a in such a way that at least one linearly adjustable piston 20a and 20b of the motorized piston cylinder device 20 can be adjusted/is adjusted by means of the controlled motor M in such a way that at least one fluid intake volume 20c and 20d of the motorized piston cylinder device 20 limited by the at least one piston 20a and 20b is variable/varied (in terms of its size). The motorized piston cylinder device 20 can be, for example, a DPB (decoupled power brake device). In particular, the first brake circuit 16 of the external power brake system can be hydraulically connected to a first fluid intake volume 20c and the second brake circuit 18 of the external power brake system to a second fluid intake volume 20d of the motorized piston cylinder device 20.

The first and second valves 22a and 22b, which can be switched by means of the primary electronic device 10a, are arranged on the external power brake system in such a way that the first wheel brake cylinder 12a is hydraulically connected to the at least one fluid intake volume 20c and 20d at least via the at least one first valve 22a and the second wheel brake cylinder 14a at least via the at least one second valve 22b. The at least one first valve 22a can be switched by means of at least one first valve switching signal 11c output by the primary electronic device 10a. Accordingly, the at least one second valve 22b can be switched by means of at least one second valve switching signal 11d output by the primary electronic device 10a. Advantageous exemplary embodiments for the first and second valves 22a and 22b will be discussed below.

The primary electronic device 10a is moreover designed and/or programmed in such a way that a brake pressure maintenance or brake pressure increase function for the first wheel brake cylinder 12a and a brake pressure reduction function for the second wheel brake cylinder 14a can be performed simultaneously by means of the primary electronic device 10a. To simultaneously perform the brake pressure maintenance or brake pressure increase function for the first wheel brake cylinder 12a and the brake pressure reduction function for the second wheel brake cylinder 14a, the motor M of the motorized piston cylinder device 20 can be controlled by means of the primary electronic device 10a such that the at least one fluid intake volume 20c and 20d of the motorized piston cylinder device 20 is increased by adjusting its at least one piston 20a and 20b by means of the controlled motor M. At the same time, by means of the primary electronic device 10a, while a brake fluid transfer from the first wheel brake cylinder 12a into the at least one increased fluid intake volume 20c and 20d is prevented by means of the at least one first valve 22a, that is switched to be closed, brake fluid from the second wheel brake cylinder 14a can be drawn/is drawn via the at least one second valve 22b, that is switched to be at least partially open, into the at least one increased fluid intake volume 20c and 20d. This can also be described as follows: while the brake pressure in the first wheel brake cylinder 12a is locked in by closing the at least one first valve 22a, the brake pressure in the second wheel brake cylinder 14acan be reduced/is reduced by drawing brake fluid into the at least one fluid intake volume 20c and 20d by means of the primary electronic device 10a.

The secondary electronic device 10b of the control device 10 is designed and/or programmed in such a way that in an electrical fault condition of the external power brake system the motor M or at least a first valve 22a and at least a second valve 22b can be controlled/are controlled by means of the secondary electronic device 10b. The motor M of the motorized piston cylinder device 20 is controllable/controlled by means of at least one motor control signal 11b output by the secondary electronic device 10b in such a way that the at least one linearly adjustable piston 20a and 20b of the motorized piston cylinder device 20 can be adjusted/is adjusted by means of the controlled motor M in such a way that at least one fluid intake volume 20c and 20d of the motorized piston cylinder device 20 limited by the at least one piston 20a and 20b is variable/varied (in terms of its size).

The first and second valves 22a and 22b, which can be switched by means of the secondary electronic device 10b, are arranged on the external power brake system in such a way that the first wheel brake cylinder 12a is hydraulically connected to the at least one fluid intake volume 20c and 20d at least via the at least one first valve 22a and the second wheel brake cylinder 14a at least via the at least one second valve 22b. The at least one first valve 22a can be switched by means of at least one third valve switching signal 11e output by the secondary electronic device 10b. Accordingly, the at least one second valve 22b can be switched by means of at least one fourth valve switching signal 11f output by the secondary electronic device 10b. Advantageous exemplary embodiments for the first and second valves 22a and 22b will be discussed below.

Advantageously, the first and second valves 22a and 22b can (usually) be switched more quietly than the wheel outlet valves 24a and 24b of the external power brake system. In particular, at least one first wheel outlet valve 24a downstream of the first wheel brake cylinder 12a and at least one second wheel outlet valve 24b downstream of the second wheel brake cylinder 14a can be controlled/held in their closed state during the simultaneous performance of the brake pressure maintenance or brake pressure increase function for the first wheel brake cylinder 12a and the brake pressure reduction function for the second wheel brake cylinder 14a.

Another advantage of the design/programming of the primary electronic device 10a and the secondary electronic device 10b lies in the use of the motorized piston cylinder device 20 to effect the brake pressure reduction in the second wheel brake cylinder 14a. With the external power brake system, in particular in its "full-function mode," the driver of the vehicle is decoupled from the external power brake system in such a way that the driver operating a brake actuation element/brake pedal (not shown) has no direct access to the hydraulics of the external power brake system. Instead, during the "full-function mode" of the external power brake system, the driver brakes into a simulator (not shown). The driver operating the brake actuation element/brake pedal therefore does not feel any feedback from the use of the motorized piston cylinder device 20 for brake pressure reduction in the second wheel brake cylinder 14a. The term "external power brake system" can refer in particular to a driver-decoupled brake system or a by-wire brake system.

In the brake system in FIG. 1, a first switching valve 22a is used as the only first valve 22a and a second switching valve 22b is used as the only second valve 22b. With the advantageous design/programming of the primary electronic device 10a and the secondary electronic device 10b, it is therefore possible to take advantage of the fact that the switching valves 22a and 22b can be switched comparatively quietly, in particular more quietly than the wheel outlet valves 24a and 24b.

For this reason, the primary electronic device 10a and the secondary electronic device 10b are designed and/or programmed in such a way that, especially when the second maximum brake pressure in the second wheel brake cylinder 14a is less than or equal to the first minimum brake pressure in the first wheel brake cylinder 12a, depending on the functional state of the external power brake system, the brake pressure maintenance or brake pressure increase function for the first wheel brake cylinder 12a and the brake pressure reduction function for the second wheel brake cylinder 14a can be/are performed simultaneously by means of the primary electronic device 10a or the secondary electronic device 10b in the manner described above. The primary electronic device 10a and the secondary electronic device 10b respectively take advantage of the fact that a check valve 22c of the first switching valve 22a, that is switched to be closed, will open only when the second maximum brake pressure is/becomes greater than the first minimum brake pressure. (The check valve 22c of the first switching valve 22a is aligned in such a way that a brake fluid transfer from the first wheel brake cylinder 12a via the check valve 22c of the first switching valve 22a to the motorized piston cylinder device 20 is prevented.) The design/programming of the primary electronic device 10a and the secondary electronic device 10b described herein thus allows the first switching valve 22a to be used as a separating valve despite it being equipped with the check valve 22c.

As an advantageous development, the control device 10, its primary electronic device 10a or its secondary electronic device 10b can additionally be designed and/or programmed in such a way that a brake pressure increase function for the first wheel brake cylinder 12a and a brake pressure reduction function for the second wheel brake cylinder 14a can be/are performed simultaneously by means of the primary electronic device 10a or the secondary electronic device 10b. This is possible in that simultaneously, while a brake fluid transfer from the first wheel brake cylinder 12a into the at least one fluid intake volume 20c and 20d increased by means of the controlled motor M is prevented by means of the at least one first valve 22a, that is switched to be closed, and brake fluid from the second wheel brake cylinder 14a can be drawn/is drawn via the at least one second valve 22b, that is switched to be at least partially open, into the at least one increased fluid intake volume 20c and 20d, additionally a pump motor Mp of at least one pump 26a and 26b of the external power brake system can be activated/is activated by means of the primary electronic device 10a or the secondary electronic device 10b such that brake fluid can be pumped/is pumped into the first wheel brake cylinder 12a by means of the at least one activated pump 26a. In particular, the primary electronic device 10a and the secondary electronic device 10b can be designed/programmed in such a way that the brake pressure increase function for the first wheel brake cylinder 12a and the brake pressure reduction function for the second wheel brake cylinder 14a can be performed/are performed together especially when the second maximum brake pressure in the second wheel brake cylinder 14a is less than or equal to the first minimum brake pressure in the first wheel brake cylinder 12a.

By means of the advantageous design/programming of the primary electronic device 10a and the secondary electronic device 10b described in the preceding paragraph, it is possible to take advantage of the fact that an external power brake system, in order to ensure good redundancy, often comprises not only the motorized piston cylinder device 20 as its first actuator, but also the at least one pump 26a and 26b as its second actuator. In addition, the design/programming of the primary electronic device 10a and the secondary electronic device 10b makes it possible to take advantage of the fact that the first wheel brake cylinder 12a together with the respectively associated pump 26a is decoupled from the motorized piston cylinder device 20 and the second wheel brake cylinder 14a by means of the at least one first valve 22a that is switched to be closed. The brake fluid pumped in the first wheel brake cylinder 12a by means of the at least one activated pump 26a during the closing/keeping closed of the at least one first valve 22a can be drawn via a first high-pressure switching valve 28a of the first brake circuit 16 which is switched to be at least partially open. By closing/keeping closed a second high-pressure switching valve 28b of the second brake circuit 18, an undesirable pressure increase in the second wheel brake cylinder 14a due to co-driving a pump 26b of the second brake circuit 18 by means of the pump motor MP can (essentially) be prevented.

After reaching a target pressure of (almost) 0 bar, or atmospheric pressure in the first wheel brake cylinder 12a and/or in the second wheel brake cylinder 14a, the at least one downstream wheel outlet valve 24a and 24b can be at least partially opened to compensate for any leakage via the at least one upstream wheel inlet valve 30a and 30b.

The external power brake system shown in FIG. 1 is merely an example of a 2-box system. A first box 32a of the 2-box system comprises the motorized piston cylinder device 20 and a brake fluid reservoir 34 hydraulically connected thereto. A second box 32b of the 2-box system has the valves 22a, 22b, 24a, 24b, 28a, 28b, 30a and 30b, the at least one pump 26a and 26b, one storage chamber 36 downstream of the wheel outlet valves 24a or 24b for each brake circuit 16 and 18, one check valve 38 arranged between the storage chamber 36 and the respective pump 26a or 26b, and a pre-pressure sensor 40 connected to the second brake circuit 18. However, the components of the external power brake system depicted in FIG. 1 are to be interpreted only as examples.

The brake pressure present in the first wheel brake cylinder 12a and the brake pressure present in the second wheel brake cylinder 14a, or the first maximum brake pressure, the first minimum brake pressure, the second maximum brake pressure and/or the second minimum brake pressure, can be a physical variable estimated by the primary electronic device 10a and the secondary electronic device 10b. Alternatively or additionally, the primary electronic device 10a and the secondary electronic device 10b can also be designed/programmed to read the brake pressure present in the first wheel brake cylinder 12a and the brake pressure present in the second wheel brake cylinder 14a, or the first maximum brake pressure, the first minimum brake pressure, the second maximum brake pressure and/or the second minimum brake pressure from at least one sensor signal of at least one sensor, such as, in particular, the pre-pressure sensor 40 connected to the second brake circuit 18.

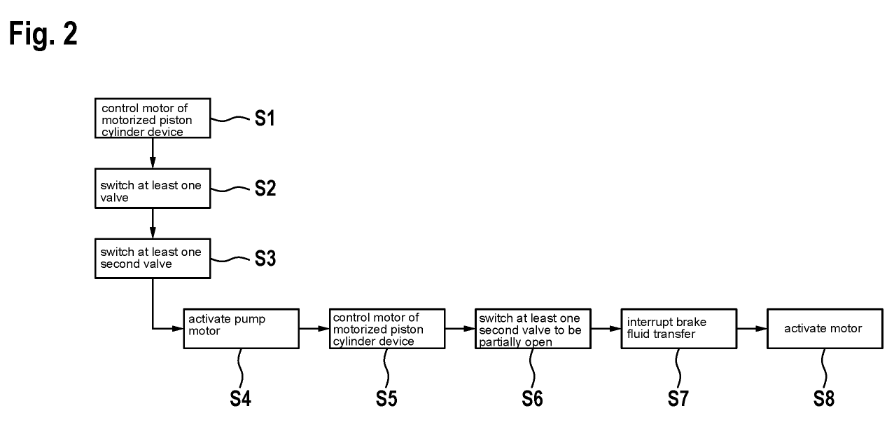

FIG. 2 shows a flowchart explaining an embodiment of the method for operating an external power brake system of a vehicle.

What is described below can, for example, be performed by means of one of the external power brake systems explained above. However, practicability of the method is not limited to such an external power brake system. Likewise, practicability of the method is not limited to any specific vehicle type/motor vehicle type of the vehicle/motor vehicle.

The method includes at least method steps S1 to S3, the simultaneous performance of which jointly effects a brake pressure maintenance or brake pressure increase function for a first wheel brake cylinder of the external power brake system arranged on an axle of the vehicle and a brake pressure reduction function for a second wheel brake cylinder of the external power brake system arranged on the axle of the vehicle. In method step S1, a motor of a motorized piston cylinder device of the external power brake system is controlled such that at least one fluid intake volume of the motorized piston cylinder device is increased by means of the controlled motor.

At the same time, in method step S2, at least one first valve of the external power brake system is switched in such a way that, while the first wheel brake cylinder is hydraulically connected to the at least one fluid intake volume at least via the at least one first valve, a brake fluid transfer from the first wheel brake cylinder into the at least one fluid intake volume increased by means of the controlled motor is prevented by means of the at least one first valve that is switched to be closed.

Likewise, in the simultaneously performed method step S3, at least one second valve of the external power brake system is switched in such a way that, while the second wheel brake cylinder is hydraulically connected to the at least one fluid intake volume via the at least one second valve, brake fluid is drawn from the second wheel brake cylinder into the at least one increased fluid intake volume via the at least one second valve that is switched to be at least partially open. In the case of an electrical fault condition of the external power brake system, the motor is controlled by means of a secondary electronic device such that at least one fluid intake volume of the motorized piston cylinder device is varied by means of the controlled motor such that a brake pressure maintenance or brake pressure increase function is performed for the first wheel brake cylinder and for the second wheel brake cylinder. Alternatively, in the case of an electrical fault condition of the external power brake system, the at least one first valve and the at least one second valve are switched by means of the secondary electronic device such that a brake pressure maintenance or brake pressure increase function is performed for the first wheel brake cylinder and for the second wheel brake cylinder.

Examples of the at least one first valve and the at least one second valve and of advantageous conditions for carrying out method steps S1 to S3, have already been explained above.

Optionally, when performing the method described herein, a brake pressure increase function for the first wheel brake cylinder and a brake pressure reduction function for the second wheel brake cylinder can be effected simultaneously by performing a method step S4 in addition to method steps S1 to S3. As method step S4, while a brake fluid transfer from the first wheel brake cylinder into the at least one fluid intake volume increased by means of the controlled motor is prevented by means of the at least one first valve that is switched to be closed, and brake fluid from the second wheel brake cylinder is drawn into the at least one increased fluid intake volume via the at least one second valve that is switched to be at least partially open (method steps S1 to S3), a pump motor of at least one pump of the external power brake system is additionally activated such that brake fluid is pumped into the first wheel brake cylinder by means of the at least one activated pump.

Likewise, when performing the method described herein, a first brake pressure reduction function with a first target gradient for the first wheel brake cylinder and a second brake pressure reduction function with a second target gradient above the first target gradient for the second wheel brake cylinder can be effected simultaneously. In a method step S5, the motor of the motorized piston cylinder device is controlled such that the at least one fluid intake volume of the motorized piston cylinder device is reduced by means of the controlled motor. At the same time, in a method step S6, the at least one second valve is switched to be partially open. However, as method step S7, which is performed during a brake fluid transfer effected by method step S6 from the at least one fluid intake volume reduced by means of the controlled motor via the at least one second valve, which is switched to be at least partially open, into the second wheel brake cylinder, a brake fluid transfer from the at least one reduced fluid intake volume is interrupted several times by means of the at least one first valve which is switched to be briefly closed.

Furthermore, when performing the method described herein, a first brake pressure increase function with a first target gradient for the first wheel brake cylinder and a second brake pressure increase function with a second target gradient above the first target gradient for the second wheel brake cylinder can be performed simultaneously. In a method step S8, the motor is activated such that a brake fluid transfer from the fluid intake volume reduced by means of the controlled motor is effected into the first wheel brake cylinder and into the second wheel brake cylinder, wherein the first valve is controlled depending on the first target gradient.

In this way, carrying out the method described herein also provides the advantages explained above.

Although the present disclosure has been explained above by way of example with reference to exemplary embodiments, it is not limited thereto, but can be modified in many ways. In particular, combinations of the above exemplary embodiments are also possible.

What is claimed is:

1. A control device for an external power brake system of a vehicle, comprising:
a primary electronic device configured in such a way that a motor of a motorized piston cylinder device of the external power brake system can be controlled using the primary electronic device such that at least one fluid intake volume of the motorized piston cylinder device can be varied using the controlled motor, and at least one first valve and at least one second valve of the external power brake system can be switched using the primary electronic device, wherein a first wheel brake cylinder of the external power brake system is hydraulically connected to the at least one fluid intake volume at least via the at least one first valve and a second wheel brake cylinder of the external power brake system at least via the at least one second valve;
wherein the primary electronic device is additionally configured in such a way that a brake pressure maintenance or brake pressure increase function for the first wheel brake cylinder, and a brake pressure reduction function for the second wheel brake cylinder, can be performed simultaneously using the primary electronic device in that at least, while a brake fluid transfer from the first wheel brake cylinder into the at least one fluid intake volume increased using the controlled motor is prevented using the at least one first valve that is switched to be closed, brake fluid from the second wheel brake cylinder can be drawn into the at least one increased fluid intake volume via the at least one second valve that is switched to be at least partially open; and
a secondary electronic device which is configured in such a way that using the secondary electronic device, in an electrical fault condition of the external power brake system:
the motor can be controlled such that at least one fluid intake volume of the motorized piston cylinder device can be varied using the controlled motor such that a brake pressure maintenance or brake pressure increase function can be performed for the first wheel brake cylinder and for the second wheel brake cylinder, or
the at least one first valve and the at least one second valve can be switched such that a brake pressure maintenance or brake pressure increase function can be performed for the first wheel brake cylinder and for the second wheel brake cylinder.

2. The control device according to claim 1, wherein the primary electronic device is additionally configured in such a way that a brake pressure increase function for the first wheel brake cylinder and a brake pressure reduction function for the second wheel brake cylinder can be performed simultaneously using the primary electronic device in that simultaneously, while a brake fluid transfer from the first wheel brake cylinder into the at least one fluid intake volume increased using the controlled motor is prevented using the at least one first valve that is switched to be closed, and brake fluid from the second wheel brake cylinder can be drawn into the at least one increased fluid intake volume via the at least one second valve that is switched to be at least partially open, a pump motor of at least one pump of the external power brake system can additionally be activated using the primary electronic device such that brake fluid can be pumped into the first wheel brake cylinder by means of the at least one activated pump.

3. The control device according to claim 1, wherein the primary electronic device is additionally configured in such a way that a first brake pressure reduction function with a first target gradient for the first wheel brake cylinder and a second brake pressure reduction function with a second target gradient above the first target gradient for the second wheel brake cylinder can be performed simultaneously using the primary electronic device in that during a brake fluid transfer from the second wheel brake cylinder via the at least one second valve, that is switched to be at least partially open, into the at least one fluid intake volume increased using the controlled motor, a brake fluid transfer from the first wheel brake cylinder into the at least one increased fluid intake volume is interrupted several times using the at least one first valve that is switched to be briefly closed.

4. The control device according to claim 1, wherein the primary electronic device is additionally configured in such a way that a first brake pressure increase function with a first target gradient for the first wheel brake cylinder and a second brake pressure increase function with a second target gradient above the first target gradient for the second wheel brake cylinder can be performed simultaneously using the primary electronic device in that the motor can be activated such that a brake fluid transfer from the fluid intake volume reduced using the controlled motor into the first wheel brake cylinder and into the second wheel brake cylinder is effected, wherein the first valve is controlled depending on the first target gradient.

5. An external power brake system, including an axle brake module, for a vehicle, comprising:
a control device, including:
a primary electronic device configured in such a way that a motor of a motorized piston cylinder device of the external power brake system can be controlled using the primary electronic device such that at least one fluid intake volume of the motorized piston cylinder device can be varied using the controlled motor, and at least one first valve and at least one second valve of the external power brake system can be switched using the primary electronic device, wherein a first wheel brake cylinder of the external power brake system is hydraulically connected to the at least one fluid intake volume at least via the at least one first valve and a second wheel brake cylinder of the external power brake system at least via the at least one second valve,
wherein the primary electronic device is additionally configured in such a way that a brake pressure maintenance or brake pressure increase function for the first wheel brake cylinder, and a brake pressure reduction function for the second wheel brake cylinder, can be performed simultaneously using the primary electronic device in that at least, while a brake fluid transfer from the first wheel brake cylinder into the at least one fluid intake volume increased using the controlled motor is prevented using the at least one first valve that is switched to be closed, brake fluid from the second wheel brake cylinder can be drawn into the at least one increased fluid intake volume via the at least one second valve that is switched to be at least partially open, and
a secondary electronic device which is configured in such a way that using the secondary electronic device, in an electrical fault condition of the external power brake system:
the motor can be controlled such that at least one fluid intake volume of the motorized piston cylinder device can be varied using the controlled motor such that a brake pressure maintenance or brake pressure increase function can be performed for the first wheel brake cylinder and for the second wheel brake cylinder, or
the at least one first valve and the at least one second valve can be switched such that a brake pressure maintenance or brake pressure increase function can be performed for the first wheel brake cylinder and for the second wheel brake cylinder;
the motorized piston cylinder device, the motor of motorized piston cylinder device being controlled using the primary electronic device and the secondary electronic device of the control device such that the at least one fluid intake volume of the motorized piston cylinder device can be varied using the controlled motor;
the first wheel brake cylinder, which can be, or is, arranged on an axle of the vehicle, and the second wheel brake cylinder, which can be, or is, arranged on the axle of the vehicle; and
the first and second valves, configured to be switched using the primary electronic device and the secondary electronic device, wherein the first wheel brake cylinder is hydraulically connected to the at least one fluid intake volume at least via the at least one first valve and the second wheel brake cylinder at least via the at least one second valve.

6. The external power brake system according to claim 5, wherein the control device is configured as a central control unit of the vehicle.

7. The external power brake system according to claim 5, wherein the axle is a rear axle of the vehicle, wherein the motorized piston cylinder device, the at least one first valve and the at least one second valve are arranged on the rear axle.

8. A method for operating an external power brake system of a vehicle, comprising the following steps:
simultaneously performing a brake pressure maintenance or brake pressure increase function for a first wheel brake cylinder of the external power brake system arranged on an axle of the vehicle and a brake pressure reduction function for a second wheel brake cylinder of the external power brake system arranged on the axle of the vehicle, at least by performing the following steps:
controlling a motor of a motorized piston cylinder device of the external power brake system such that at least one fluid intake volume of the motorized piston cylinder device is increased using the controlled motor,
switching at least one first valve of the external power brake system in such a way that, while the first wheel brake cylinder is hydraulically connected to the at least one fluid intake volume at least via the at least one first valve, a brake fluid transfer from the first wheel brake cylinder into the at least one fluid intake volume increased using the controlled motor is prevented using the at least one first valve that is switched to be closed, and
switching at least one second valve of the external power brake system in such a way that, while the second wheel brake cylinder is hydraulically connected to the at least one fluid intake volume via the at least one second valve, brake fluid is drawn from the second wheel brake cylinder into the at least one increased fluid intake volume via the at least one second valve that is switched to be at least partially open;
wherein in then event of an electrical fault condition of the external power brake system, a secondary electronic device is used to either:
control the motor such that at least one fluid intake volume of the motorized piston cylinder device is varied using the controlled motor such that a brake pressure maintenance or brake pressure increase function is performed for the first wheel brake cylinder and for the second wheel brake cylinder, orswitch the at least one first valve and the at least one second valve such that a brake pressure maintenance or brake pressure increase function is performed for the first wheel brake cylinder and for the second wheel brake cylinder.

9. The method according to claim 8, wherein a brake pressure increase function for the first wheel brake cylinder and a brake pressure reduction function for the second wheel brake cylinder are performed simultaneously in that simultaneously, while a brake fluid transfer from the first wheel brake cylinder into the at least one fluid intake volume increased using the controlled motor is prevented using the at least one first valve that is switched to be closed, and brake fluid from the second wheel brake cylinder is drawn into the at least one increased fluid intake volume via the at least one second valve that is switched to be at least partially open, a pump motor of at least one pump of the external power brake system is additionally activated such that brake fluid is pumped into the first wheel brake cylinder using the activated at least one pump.

10. The method according to claim 8, wherein a first brake pressure reduction function with a first target gradient for the first wheel brake cylinder and a second brake pressure reduction function with a second target gradient above the first target gradient for the second wheel brake cylinderare simultaneously performed in that, during a brake fluid transfer from the at least one fluid intake volume reduced using the controlled motor via the at least one second valve, that is switched to be at least partially open, into the second wheel brake cylinder, a brake fluid transfer from the at least one reduced fluid intake volume is interrupted several times using the at least one first valve that is switched to be briefly closed.

11. The method according to claim 8, wherein a first brake pressure increase function with a first target gradient for the first wheel brake cylinder and a second brake pressure increase function with a second target gradient above the first target gradient for the second wheel brake cylinder are performed simultaneously in that the motor is activated such that a brake fluid transfer from the fluid intake volume reduced using the controlled motor into the first wheel brake cylinder and into the second wheel brake cylinder is effected, wherein the first valve is controlled depending on the first target gradient.
